(19) United States
(12) Patent Application Publication
(10) Pub. No.: US 2011/0185301 A1
(43) Pub. Date: Jul. 28, 2011

(54) Providing sensory information based on detected events

(76) Inventors: Mark Geller, Los Angeles, CA (US); Rodney Morison, Altadena, CA (US)

(21) Appl. No.: 12/931,184

(22) Filed: Jan. 26, 2011

Related U.S. Application Data
(60) Provisional application No. 61/336,862, filed on Jan. 27, 2010.

(51) Int. Cl. G06F 3/048

(52) U.S. Cl. 715/769; 715/771

(57) ABSTRACT

An electronic device is described. During operation, the electronic device may receive information associated with an event, which was detected by a hooking software program while the information was conveyed to an environment (such as an operating system) of the electronic device. For example, the event may be a user-interface operation, such as a click-drag operation, which may be performed using a mouse (and, more generally, using a user-interface device). Moreover, in response to the received information, the electronic device may provide sensory information via the hooking software program. This sensory information may be other than sensory information associated with native operations executed in the environment during a user session prior to the event. Thus, the electronic device may expand the functionality associated with the environment (without modifying software associated with the environment) and, in particular, the functionality associated with events, such as click-drag operations.

### CROSS REFERENCE TO RELATED APPLICATIONS

This application claims priority under 35 U.S.C. 119(e) to U.S. Provisional Application Ser. No. 61/336,862, entitled “Technique for Enhancing Click-Drag Operations in User Interfaces,” by Mark Geller et al., filed on Jan. 27, 2010, and having attorney docket number KF-1001, the contents of which are herein incorporated by reference.

### BACKGROUND

1. Field of the Invention

The present disclosure relates to providing sensory information in electronic devices. More specifically, the present disclosure relates to providing sensory information on computers based on events that are detected using a hooking software program.

2. Related Art

User interfaces, such as graphical user interfaces, are increasingly popular architectures that allow users to provide and receive sensory information while using an electronic device, such as a computer. One type of user interface is a pointer and keyboard-controlled graphics system, such as a mouse, a keyboard and a display attached to a computer, which executes operations associated with this type of user interface.

A pointer and keyboard-controlled graphics system typically supports a variety of operations including a so-called ‘click-drag’ operation using the mouse. During a click-drag operation, a user of the computer may place a pointer or cursor proximate to an object that is displayed, and may left click on this object using the mouse selection button. While continuing to left click on the object, the user may drag this object to another location on the display screen using the mouse. Click-drag operations may be used to activate one or more operations that are executed in an environment in the computer, for example, by the operating system. In particular, click-drag operations may be used to: create new content, such as shapes in a drawing or a graphical design application; add existing content to a selection list, such as the selection of files or folders on a computer ‘desktop’ (which is displayed on a computer screen or display); add existing content to text and images in an application, such as a web browser; and/or to ‘drag-and-drop’ content, in which selected content is moved to a new location in a user interface. In the discussion that follows, ‘drag and drop’ refers to a process of using a click-drag operation to move content in a user interface, ‘drag select’ includes the process of using a click-drag operation to modify a selection list, text or images, and ‘drag draw’ includes the process of using a click-drag operation to create new content.

During or after a click-drag operation, visual feedback may be provided to the user. This visual feedback may include: a wireframe or an opaque rectangle at the minimum bounding box (mbb) of the rectangle, for example, a rectangle spanning the initial click point to the current pointer position; new content rendered in the interior of the rectangle; so-called ‘selection effects’ that indicate content within or touching the selection rectangle (for example, a light-colored rectangle surrounding the object) that may be affected by a current or a subsequent operation; an icon moving in tandem with the pointer; and/or other visual feedback related to the pointer movement.

Note that click-drag user interfaces are present in many graphical software programs, including the operating-system graphics management program (which is often referred to as the ‘desktop window manager’). However, because click-drag operations and the associated graphics are generally engineered directly into such graphical software programs, it is often difficult to customize or extend the associated features beyond the operations that are included in the graphical software programs (which, in the case of the operating system, are henceforth referred to as ‘native operations’).

Furthermore, click-drag operations typically involve real-time graphics on human sensory-response timescales. However, the high-quality of graphics hardware and software often leads users to expect displayed graphics be ‘smooth’ (as opposed to jumpy or laggard), which, nonetheless, is sometimes difficult to achieve in existing pointer and keyboard-controlled graphics systems.

Additionally, in existing pointer and keyboard-controlled graphics systems, it is often difficult or impossible for users to activate or perform a click-drag operation to implement click-drag functionality beyond that of the application or web page running in an active window while the pointer is positioned within the active window. Indeed, attempts to implement modified click-drag functionality by changing the computer code in the graphical software programs that implement click-drag operations is usually not allowed by the developer(s) of the graphical software programs.

Hence what is needed is a technique for enhancing the functionality of click-drag operations in graphical software programs without the problems listed above.

### SUMMARY

One embodiment of the present disclosure relates to an electronic device (such as a computer or a computer system) that provides sensory information. During operation, the electronic device receives information associated with an event from a hooking software program. Note that the information was detected by the hooking software program while the information was conveyed to an environment of the electronic device, and the hooking software program executes in the environment. In response to the received information, the electronic device provides sensory information via the hooking software program, where the sensory information is other than sensory information associated with native operations executed in the environment during a user session prior to the event.

In some embodiments, the environment includes an operating system of the electronic device. Moreover, the sensory information may be displayed in a window in a user interface of the electronic device, where the window is superimposed over a background that is associated with an operating system of the electronic device. Furthermore, the sensory information may be associated with a software program that executes in the environment. This software program may be included in or may be separate from the operating system.

Note that the event may include a user-interface operation. For example, the user-interface operation may include a click-drag operation, and the click-drag operation may include: a first drag-select operation that selects an object displayed in the user interface, a second drag-select operation that selects a region in the user interface that does not include the object, a first drag-drop operation that moves the object displayed in the user interface, and/or a second drag-drop operation that creates a new object that is displayed in the user interface. (However, in some embodiments the user interface operation may involve activating a user-interface device without moving it. For example, a user may click on a mouse selection button without dragging or selecting.) Moreover, the sensory information may be provided based on activation configuration instructions, where the activation configuration instructions include: instructions to provide the sensory information if the user-interface operation has at least a minimum duration; instructions to provide the sensory information if the user-interface operation has a duration exceeding a pre-defined value; instructions to provide the sensory information if the user-interface operation occurs at an arbitrary location in the user interface; instructions to provide the sensory information if the user-interface operation occurs a location in the user interface that satisfies a predefined graphical characteristic; and/or instructions to provide the sensory information if the user-interface operation occurs in a predefined subset of the user interface.

Additionally, the hooking software program may include a hooking callback operation and a signal/slots notification operation which provide an intercepted-event notification-broadcast operation. This intercepted-event notification-broadcast operation can notify multiple recipients in the environment based on the detected event.

In some embodiments, the sensory information is displayed in the window in the user interface of the electronic device, where the sensory information is associated with additional sensory information that is displayed in a second window in the user interface. Moreover, the sensory information may be visually and contextually associated with the additional sensory information.

The sensory information displayed in the window may include: one or more images, an animation sequence, and/or a game. Alternatively or additionally, the window may be semi-transparent, thereby allowing at least a portion of a second window to be observed through the window. In some embodiments, the sensory information is provided based on display configuration instructions, and the display configuration instructions include: positioning the window on top of the background; positioning the window underneath other windows in the user interface; and/or positioning the window on top of the other windows in the user interface.

Another embodiment provides a method that includes at least some of the operations performed by the electronic device.

Another embodiment provides a computer-program product for use with the electronic device. This computer-program product includes instructions for at least some of the operations performed by the electronic device.

Another embodiment provides a second electronic device (which may be the same or different than the first electronic device) that performs an operation. This second electronic device receives a request from a third electronic device via a network. In response to the request, the second electronic device activates an application on the second electronic device. Then, the second electronic device performs the operation based on the request using the application, where the operation is other than operations performed by the second electronic device when the request was received.

Note that the application may include a web server. Moreover, the request may include a Hypertext Transfer Protocol request, and the third electronic device may function as a client in a client-server architecture.

Furthermore, the application may be included in or separate from an operating system of the second electronic device.

Additionally, the operation may include: providing sensory information; and/or displaying a window with the sensory information, where the window is superimposed over one or more other windows that were displayed on the second electronic device prior to receiving the request.

In some embodiments, performing the operation is gated by occurrence of an event. This event may include a user-interface operation on the second electronic device. For example, the user-interface operation may involve: when a cursor stops moving, when the cursor starts moving, and/or activation of a physical or a virtual icon in the user interface. Alternatively or additionally, the event may include: a time of day, an expired time, and/or activation of another application and a given operating-system operation.

Another embodiment provides a method that includes at least some of the operations performed by the second electronic device.

Another embodiment provides a computer-program product for use with the second electronic device. This computer-program product includes instructions for at least some of the operations performed by the second electronic device.

### BRIEF DESCRIPTION OF THE FIGURES

FIG. 1 is a flow chart illustrating a method for providing sensory information in accordance with an embodiment of the present disclosure.

FIG. 2 is a drawing illustrating a user interface in accordance with an embodiment of the present disclosure.

FIG. 3 is a drawing illustrating enhanced drag-select operations in a user interface in accordance with an embodiment of the present disclosure.

FIG. 4 is a flow chart illustrating a method for performing an operation in accordance with an embodiment of the present disclosure.

FIG. 5 is a flow chart illustrating the method of FIG. 4 in accordance with an embodiment of the present disclosure.

FIG. 6 is a block diagram illustrating a system that performs the method of FIGS. 4 and 5 in accordance with an embodiment of the present disclosure.

FIG. 7 is a block diagram illustrating an electronic device that performs the methods of FIG. 1, 4 or 5 in accordance with an embodiment of the present disclosure.

FIG. 8 is a block diagram illustrating a data structure for use in the electronic device of FIG. 7 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of an electronic device, a method, and a computer-program product (e.g., software) for use with the electronic device are described. During operation, the electronic device may receive information associated with an event, which was detected by a hooking software program while the information was conveyed to an environment (such as an operating system) of the electronic device. For example, the event may be a user-interface operation, such as a click-drag operation, which may be performed using a mouse (and, more generally, using a user-interface device). Moreover, in response to the received information, the electronic device may provide sensory information via the hooking software program. This sensory information may be other than sensory information associated with native operations executed in the environment during a user session prior to the event. Thus, the electronic device may expand the functionality associated with the environment (without modifying software associated with the environment) and, in particular, the functionality associated with events, such as click-drag operations.

By expanding the functionality, this user-interface technique may allow user-interface operations, such as click-drag operations, to be improved and/or customized, and may allow the sensory information (such as real-time graphics) to be provided on human sensory-response timescales. Moreover, the expanded functionality may facilitate features, such as: so-called ‘global event hooks’ (in which multiple recipients in the environment are notified based on the detected event) and/or semi-transparent overlaid windows. Consequently, the user-interface technique may improve customer satisfaction, with a commensurate impact on customer loyalty and the revenue of a provider of the user-interface technique.

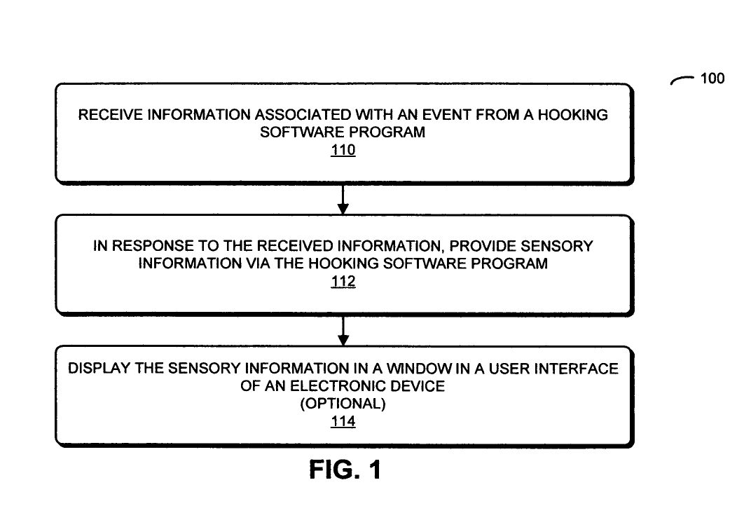

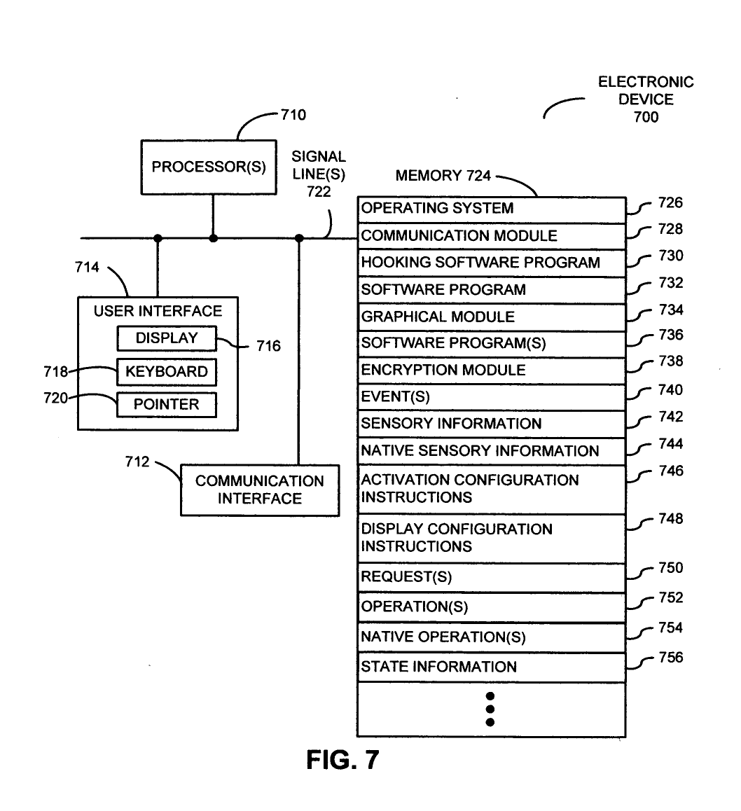

We now describe embodiments of the user-interface technique. FIG. 1 presents a flow chart illustrating a method 100 for providing sensory information, which may be performed by an electronic device, such as electronic device 700 (FIG. 7), which may be a computer or a computer system. During operation, the electronic device receives information associated with an event from a hooking software program (operation 110). Note that the information was detected by the hooking software program while the information was conveyed to an environment of the electronic device, and the hooking software program executes in the environment. In some embodiments, the environment includes an operating system of the electronic device.

In response to the received information, the electronic device provides sensory information via the hooking software program (operation 112), where the sensory information is other than sensory information associated with native operations executed in the environment during a user session prior to the event. For example, the sensory information may include sound and/or graphical information.

This sensory information may be optionally displayed in a window in a user interface of the electronic device (operation 114), where the window is superimposed over a background (such as a computer ‘desktop’ that is displayed on a computer screen or display) that is associated with an operating system of the electronic device. (In this discussion, note that the computer desktop may be the base-level working area of the user interface that may show a background graphic or ‘wallpaper’ image, as well as icons or objects for launching or accessing software programs or other content on an electronic device, a computer or a computer system.) Furthermore, the sensory information may be associated with a software program that executes in the environment. This software program may be included in or may be separate from the operating system.

In some embodiments, the sensory information optionally displayed in the window in the user interface of the electronic device is associated with additional sensory information that is displayed in a second window in the user interface. Moreover, the sensory information may be visually and contextually associated with the additional sensory information. For example, in response to the event, the software program may ‘look at’ the content in the first window and manipulate it or appear to manipulate it in the sensory information displayed in the second window. In particular, the user may perform a click-drag operation on the computer desktop to select a file folder in a rectangle. Rather than simply selecting the folder, the software program may make the displayed folder icon move randomly (or pseudo-randomly) and bounce off the walls or sides of the rectangle. Alternatively, if the user selects text in a web browser, the software program may make the displayed text appear to melt or the displayed letters may move around (such as in a random walk) and rearrange themselves. In this way, the software program and/or the hooking software program may make the content in the first window appear (i.e., the additional sensory information) to be manipulated or modified.

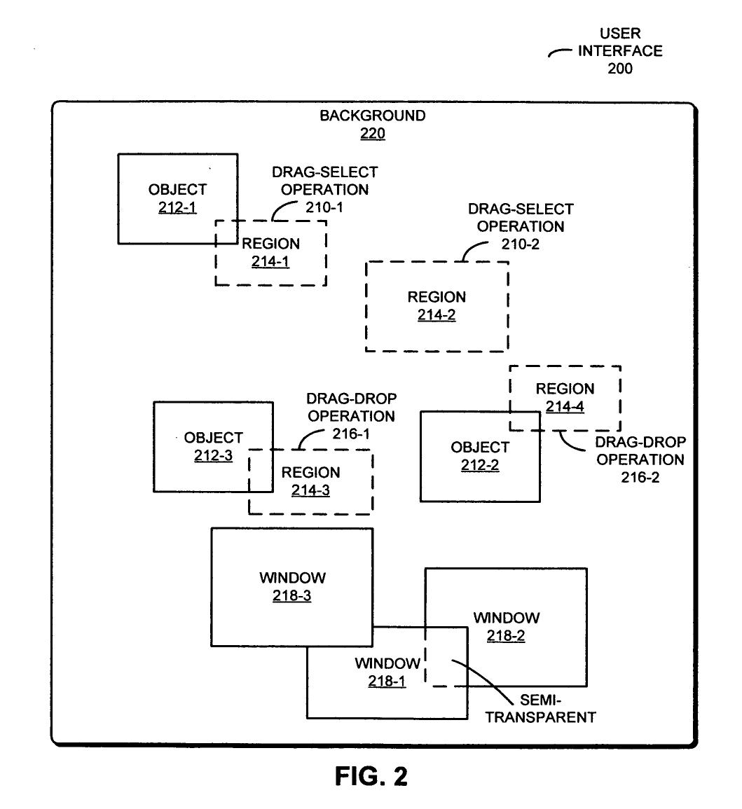

Note that the event may include a user-interface operation which is associated with a user-interface device (such as a mouse, a pointer, a touchpad, a trackpad, a touch screen, a keyboard, graphics-display hardware, a gesture-based recognition system, etc.). In particular, as shown in FIG. 2, which presents a drawing illustrating a user interface 200, the user-interface operation may include a click-drag operation, such as: a drag-select operation 210-1 that selects region 214-1 and an object 212-1 displayed in user interface 200, a drag-select operation 210-2 that selects a region 214-2 in user interface 200 that does not include one of objects 212, a drag-drop operation 216-1 (which is associated with region 214-3) that moves object 212-2 displayed in user interface 200, and/or a drag-drop operation 216-2 (which is associated with region 214-4) that creates a new object 212-3 that is displayed in user interface 200. (However, in some embodiments the user interface operation may involve activating a user-interface device without moving it. For example, a user may perform a ‘click-hold operation,’ in which the user clicks on a mouse selection button without dragging or selecting.)

Moreover, the sensory information may be provided based on activation configuration instructions, where the activation configuration instructions include: instructions to provide the sensory information if the user-interface operation has at least a minimum duration (such as 1, 2 or 5 s); instructions to provide the sensory information if the user-interface operation has a duration exceeding a pre-defined value (such as 1, 2 or 5 s); instructions to provide the sensory information if the user-interface operation occurs at an arbitrary location in user interface 200; instructions to provide the sensory information if the user-interface operation occurs a location in user interface 200 that satisfies a predefined graphical characteristic (such as within 1, 2 or 5 inches of one of objects 212); and/or instructions to provide the sensory information if the user-interface operation occurs in a predefined subset of user interface 200 (such as the right-half of user interface 200).

As noted previously, in response to the user-interface operation the sensory information may be displayed in a window, such as window 218-1 (i.e., window 218-1 and the sensory information may be displayed). The sensory information displayed in window 218-1 may include: one or more images, an animation sequence, and/or a game. Alternatively or additionally, window 218-1 may be semi-transparent, thereby allowing at least a portion of window 218-2 or background 220 (such as a computer desktop) to be observed through window 218-1. In some embodiments, the sensory information is provided based on predefined display configuration instructions, and the display configuration instructions may include: positioning window 218-1 on top of background 220; positioning window 218-1 underneath other windows (such as window 218-3) in user interface 200; and/or positioning window 218-1 on top of other windows (such as window 218-2) in user interface 200.

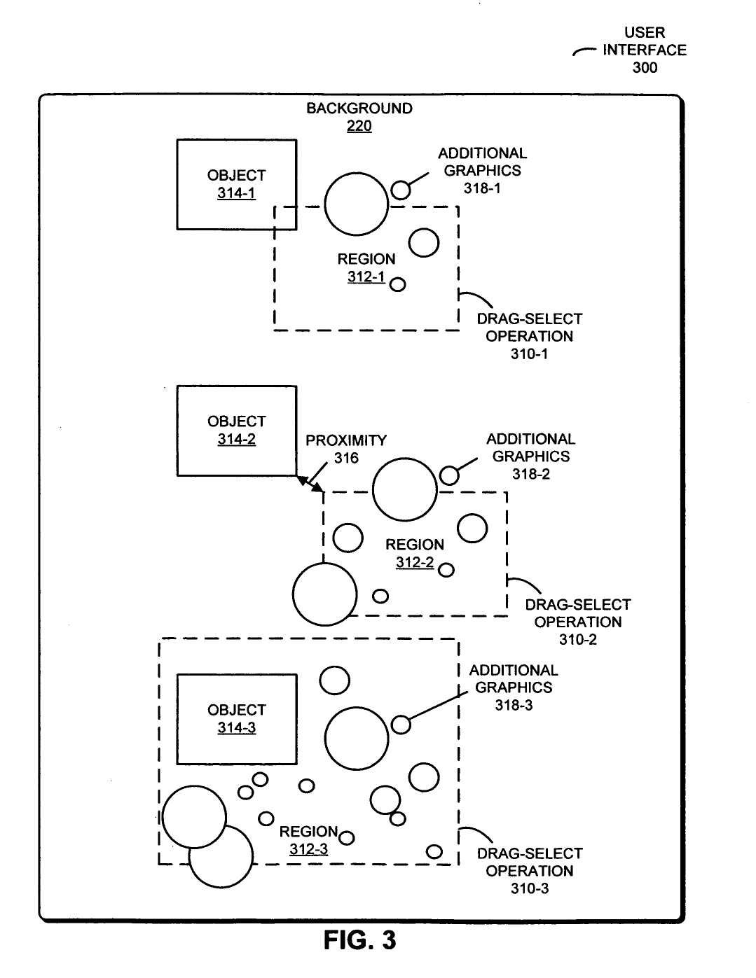

As shown in FIG. 3, which presents a drawing illustrating enhanced drag-select operations 310 in a user interface 300, in some embodiments enhanced graphics are drawn in and around drag-select rectangle(s) (or rectangle(s) associated with another user-interface operation) when one or more icons or objects displayed on the computer desktop (which are displayed on a computer screen) are drag selected. In particular, drag-select operations 310 may be associated with regions 312 that partially overlap object 314-1, completely overlap object 314-3, or which do not overlap object 314-2 (i.e., region 312-2 is in proximity 316 to object 314-2). In addition, when one of drag-select operations 310 occurs, additional graphics 318 may be displayed.

In an exemplary embodiment, the hooking software program may include a so-called ‘hooking callback operation’ and a so-called ‘signal/slots notification operation’ which provide an intercepted-event notification-broadcast operation. This intercepted-event notification-broadcast operation can notify multiple recipients (such as software programs or modules) in the environment based on the detected event.

Moreover, the event, such as a click-drag operation, may initiate the providing of the sensory information based on activation configuration instructions, such as a type of activation mode. For example, the activation mode may be ‘instantaneous’ (i.e., as soon as the click-drag operation is detected by the hooking software program), or a 1 s activation anywhere on a display (such as the computer desktop) or in a window may be used (i.e., the user may need to click down with the mouse or user-interface device for 1 s before the sensory information is provided). Similarly, the sensory information may be provided based on display configuration instructions that specify whether the sensory information is provided: on top of the other information on a display (for example, on top of the computer desktop) or under all other windows; or on top of all windows (i.e., overlaid on the active windows, which are associated with other software programs).

We now illustrate the user-interface technique in embodiments where the electronic device is a computer equipped with a graphics display, a pointer and/or a keyboard, and which is running an operating system (which provides the environment). In the typical operating mode of existing user-interface programs, pointer and keyboard events are delivered to a software program that is associated with the active window (which is sometimes referred to as the ‘top window’ or ‘window with input focus’). The software program associated with the input-focused window (which is sometimes referred to as a ‘software program with input focus’ or an ‘input-focused software program’) receives the asynchronous event signals along with contextual information regarding events, e.g., button clicks, key presses, pointer-screen position and, more generally, one or more user-interface inputs.

Because of this standard practice regarding focused windows, it is usually not possible for another software program to respond to the same event(s) to which the focused window responds. However, some user-interface systems provide access to a so-called ‘global’ event queue. The global event queue is typically data managed by the operating system with so-called ‘master’ event information, which is usually independent of any software programs, focused or not. Note that events in the global event queue are usually delivered to appropriate subscribing software programs, e.g., those associated with the focused windows.

One mode of access to the global event queue supported by Microsoft Windows™ (a trademark on Microsoft Corporation of Redmond, Wash.) is called a ‘low-level hook.’ A low-level hook allows a software program or application to receive copies of and, optionally, to modify or detect events before they are delivered to a different software program with input focus. This type of software program is called a ‘hooking software program.’ Note that low-level hooks can be processed in real-time relative to human interface timescales (e.g., relative to the human sensory-response timescale).

In an exemplary embodiment of the user-interface technique, a software program can access events from the global event queue using a low-level event hook. The event information may then be used in the hooking software program to implement features independent and separate from the software program with input focus, but with knowledge of events that will be received by the input-focused software program. In this mode of operation, the hooking software program usually passes events back to the global event queue for ultimate delivery to the software program with input focus. In addition the hooking software program can use its knowledge of the events being delivered to the input-focused software program to add graphics that alter the graphical feedback associated with the pointer and keyboard events (and, more generally, the graphical feedback associated with user-interface events or operations).

Thus, the hooking program operating in this mode can alter and enhance user interaction with other software programs without specialized knowledge of the internal code associated with these other software programs. As a consequence, the global event queue and easily observable (or detectable) user-interface behavior of the other software programs can be used in conjunction with the hooking software program to implement the user-interface technique.

Note that the graphical enhancements added by the hooking software program may use specialized drawing techniques in order to draw smoothly and to appear integrated so as to properly enhance the user interface of the other software programs. One embodiment of such a specialized drawing technique uses semi-transparent windows (such as window 218-1). In this discussion, a semi-transparent window is a window on a display (such as a computer screen) that has one or more of the following properties: borderless and without a title bar; partially or totally transparent, thereby allowing some or all of the underlying graphics to show through and to be mixed with the graphics associated with the semi-transparent window; and/or a mixture of partially and totally transparent regions, e.g., some regions of semi-transparency that mix with underlying graphics, combined with other regions that are completely transparent and that show all underlying graphics as if there was no window in that region.

In this example, the hooking software program may draw or render a semi-transparent window. This window may be completely invisible except where the hooking software program determines that enhanced graphics are warranted (such as additional graphics that are displayed in response to a user-interface operation), thus giving the appearance or impression to a user of the computer that the hooking software program is responding in tandem with the underlying input-focused software program.

In a variation on this embodiment, the hooking software program may draw semi-transparent windows over the entirety of an underlying application window or over the full display or computer screen. Then, in the semi-transparent window, the size and shape of visible and completely invisible regions may be altered to integrate with events and graphics in windows associated with the other software programs. This approach may facilitate integration with underlying software programs without having to use a resize operation on the semi-transparent window (which can result in jumpiness and other undesirable visual effects).

In the preceding discussion, the operating system may include a variety of operating systems, including real-time or embedded operating systems. For example, the operating system may include: Windows XP™ (which is a trademark of the Microsoft Corporation of Redmond, Wash.), Windows Vista™ (which is a trademark of the Microsoft Corporation of Redmond, Wash.), Windows 7™ (which is a trademark of the Microsoft Corporation of Redmond, Wash.), Windows™ Mobile (a trademark of the Microsoft Corporation of Redmond, Wash.), an Apple™ operating system, such as OS X (a trademark of Apple, Inc. of Cupertino, Calif.), Linux™ (a trademark of Linus Torvalds), UNIX™ (a trademark of the Open Group), the Chrome™ operating system (a trademark of Google, Inc. of Mountain View, Calif.), the Android™ operating system (a trademark of Google, Inc. of Mountain View, Calif.), and/or the Symbian™ operating system (a trademark of Symbian Software, Ltd.).

In an exemplary embodiment of the low-level hook supported by Microsoft Windows™, a software library may include the computer coded functions ‘keyboardCallBack’ and ‘mouseCallBack,’ which respectively set the keyboard and a mouse (or a pointer) callback function. These functions may be passed to the Microsoft Windows™ system interface function ‘SetWindowsHookEx’ with the so-called ‘idHook’ value set to ‘WH_KEYBOARD_LL’ and ‘WH_MOUSE_LL,’ respectively.

This implementation of keyboardCallBack and mouseCallBack may invoke another function outside the aforementioned library that implements graphics functions. These graphics functions may respond to graphical user-interface state variables supplied to keyboardCallBack and mouseCallBack, which are provided to those graphics functions. In particular, this embodiment may use graphics functions operating on graphics windows created using the Microsoft Windows™ system function ‘SetWindowLong’ with the style attribute ‘WX_EX_LAYERED.’ Furthermore, the graphics windows set with the WX_EX_LAYERED state may be manipulated using the ‘SetLayedWindowAttibutes’ function with the values ‘LWA_COLOR_KEY’ and ‘LWA_ALPHA,’ along with other graphics drawing functions associated with the Microsoft Windows™ operating system.

Subsequently, when a user generates a keyboard or mouse event (and, more generally, when the user performs a user-interface operation), the keyboardCallBack or mouseCallBack function may be executed in the hooking software program. Moreover, the hooking software program may queue a copy of this event into its own event queue, and may return the event to the global event queue for delivery to the other software program(s). Furthermore, the hooking software program may process its copy of the event to implement custom logic and graphics in tandem with the other software program(s). In this way, the hooking software program may interface to the global event queue.

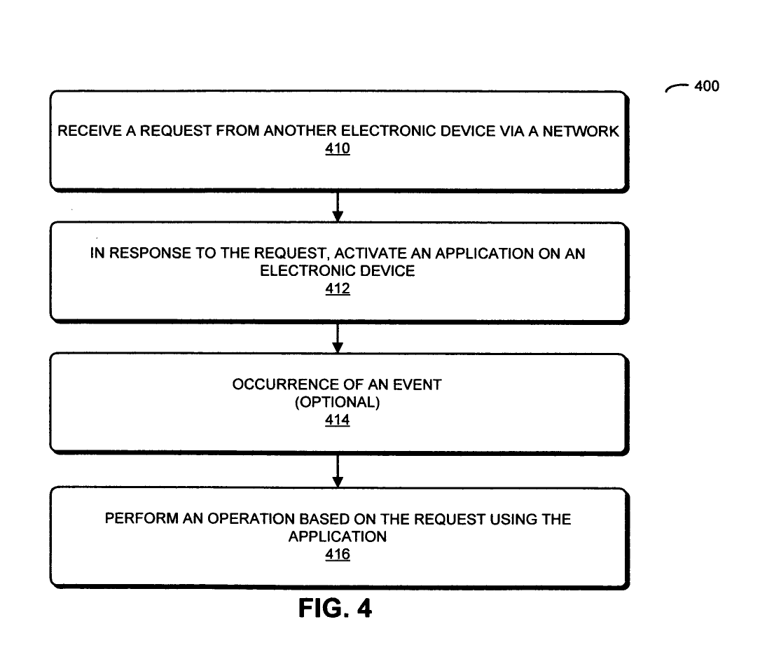

While a computer (or equivalently a computer system) is used as an illustration in this discussion, in other embodiments the user-interface technique may be implemented on a variety of electronic devices that have an associated display or screen, including electronic devices other than desktop or laptop computers. These electronic devices may include: a cellular telephone, a personal digital assistant, a smartphone, a netbook, an e-reader, a tablet computer, a television, a set-top box, and/or a digital video recorder. Furthermore, the user-interface technique may be implemented using a different form or structure beside a resident ‘desktop’ application (e.g., a software program running as its own process on the user's computer), for example, as a web browser plug-in application or using a client-server architecture, in which some or all of the functionality is provided by a remote application that is not stored on the user's computer or electronic device (one embodiment of which is described further below with reference to FIG. 4).

In some embodiments, the user-interface technique is implemented using a user-interface input device beside a tethered computer mouse. For example, a wide variety of user-interface devices may be used, including: a wireless mouse, a computer trackpad, a pointer, a pointing stick, another physical pointing device (such as a touch screen or touchpad that responds to one or more fingers and/or a stylus), a keyboard, graphics-display hardware, visual recognition of one or more physical gestures (i.e., with or without a separate physical pointing device), a remote control, a motion sensor, a cellular telephone, another wireless device, and/or more generally, a device that is responsive to a user-selection input provided by a user. Thus, the user-interface technique may be implemented using other activation techniques besides a mouse click, such as: a keyboard input, one or more gestures, and/or a physical touch/tap associated with a user's finger(s) or a stylus.

Note that, in some embodiments, the user-interface technique may be implemented using another user-interface operation to activate or operate the expanded or customized functionality. For example, instead of a click-drag operation, the user may activate the functionality by clicking and holding the mouse for a period of time (e.g., without moving the pointer location while holding the mouse selection button). Alternatively, the user may click in a region of the screen (or the user interface) that is characterized by a particular visual display or functionality. Thus, the user may click once in a region where: the cursor is surrounded by all ‘white’ pixels for N pixels in one or more directions (such as 10, 50, 100 or 500 pixels); there is a prescribed shape of the pixels; where there are pixels of another single color other than white; and/or where there is a gradient or repeating pattern. Alternatively or additionally, the user may click on a particular region of the screen (e.g., a rectangle 200×150 pixels in the upper right portion of the screen), or on a single designated screen that is part of a multi-screen display. In these embodiments, certain elements or regions of the screen may be excluded from potential activation in order to avoid unwanted or unintentional activations. For example, the computer may not activate the user-interface technique when the user clicks on: a scrollbar, the system tray, or, for Microsoft Windows™, the ‘Start’ button.

The embodiments of the user-interface technique may allow a user to access a single type of enhanced functionality or one or more mini-applications (which are henceforth referred to as ‘mini-apps’), beside the click-drag-operation functionality offered by the hooking software program. These mini-apps may be included directly with the above embodiments, or they may be incorporated later, for example, by downloading them from a remote server in a client-server architecture.

For example, the user may select which mini-app(s) to make active by accessing a menu using an icon in the ‘system tray’ or taskbar. Alternatively or additionally, the user may select one or more active mini-app(s) by clicking icons that are displayed onscreen during the use of the (main) active software program. Note that the user may have multiple mini-apps active at a given time, where the mini-apps in question are activated using different, non-conflicting user-interface operations or user-selection techniques. For example, mini-apps may be activated by performing: a click-drag operation on the computer desktop, a click-hold operation on top of a window associated with a software program or application (i.e., overlaid on this window), a gesture with a mouse, a pointer or another input device, etc.

Furthermore, the user may select which mini-app to activate by displaying icons or symbols that are associated multiple mini-apps during the activation process. For example, when the user performs a click-hold operation on top of a window (i.e., overlaid on this window), several mini-app icons may be displayed near the cursor. In response, the user may move the mouse cursor over the desired mini-app(s) and release it or, while the icons are displayed, may click a second time on the icon for a desired mini-app(s). However, in some embodiments, a mini-app is selected at random (or pseudo-randomly) by the software program associated with the window or by the hooking software program for a given event, e.g., with each click-drag operation performed on the computer desktop a different pattern or animation chosen at random (or pseudo-randomly) may be displayed.

Additionally, the user may use the above mini-app selection technique to change settings for other aspects of the operating system, such as: changing the desktop wallpaper, the desktop theme, a mouse cursor design (for example, to something other than an arrow), etc. The user may also use the above mini-app selection technique to select windows that are associated with different software programs.

We now describe additional embodiments of mini-apps. These mini-apps may be implemented using the hooking software program or using a different technique that is implemented in hardware and/or software (such as method 400, which is described below with reference to FIG. 4). Furthermore, as shown in FIG. 2, in some embodiments, when selected, a mini-app overlays a semi-transparent (or non-transparent) photograph in window 218-1 over some or all of the selection window, or overlays other visual elements over the selection window (such as an alternate color, a pattern, and/or an animation).

In some embodiments, when selected, a mini-app displays textual content or a combination of text and graphics within some or all of the selection window associated with the user-interface operation, or in another window or region created using the user-interface technique. This content may be stored on the user's local computer or may be accessed and downloaded over a network, such as the Internet. Moreover, the content may be linked to one or more web pages or content on the network, such that, if the user clicks or releases on or proximate to an object that is associated with linked content, the one or more web pages or content are displayed. Note that the user may move through or navigate through this content by clicking a scrollbar or by making gestures with a pointing device, such as by: performing a circular motion (clockwise or counter-clockwise), by moving up and down, or by moving side-to-side. These gestures maybe part of the user-interface operation that is used to activate the mini-app or may be a separate subsequent gesture.

In some embodiments, when selected, a mini-app displays content (text, graphics, photographs, etc.) in one or more of the four quadrants on the user interface (e.g., to the upper-right, lower-right, lower-left, and upper-left of the initial click or activation point). For example, if the user activates a mini-app by performing a click-hold operation, and then moves the pointer in a clockwise direction around the activation point, as the pointer moves into each quadrant, a new piece of content (e.g., one or more photographs) may be displayed in that quadrant. Furthermore, the content may be displayed sequentially in a prescribed order (e.g., the photos in an album may be displayed in chronological order as the user moves clockwise, or in reverse-chronological order if the user moves counter-clockwise), or at random (or pseudo-randomly).

In this mini-app, new content may be displayed by the user by moving the cursor back and forth between two or more quadrants, or between any of two or more user-interface regions defined by the mini-app. For example, a ‘flashcard’ technique may be used, in which, as the user moves the mouse back-and-forth between two regions, a first new word is revealed, followed by its definition/translation, then a second new word is displayed, followed by its definition/translation, etc. To use this mini-app, the user may or may not continue holding down/engaging the mouse (or another user-interface device) while moving the cursor.

In some embodiments, when selected, a mini-app overlays a game or another user activity within or connected to the bounds of the selection window associated with the user-interface operation so that the game/activity appears to take place within the selection window. This game or activity may be influenced by the position and/or movement of the bounding box for the selection window. For example, a mini-app may display a ‘bouncing ball’ within the selection window. When the ball hits the walls or boundaries of the selection window, it may appear to ‘bounce’ off them, thereby mimicking the way a real ball bounces off of a physical wall. Note that subsequent user-interface operations after the mini-app is activated may be used to move the selection window boundaries in a certain way to ‘contain’ the ball (e.g., to influence the ball to remain within certain prescribed boundaries, such as a bounding box or region, or within the entire screen). In this way, continuing the activity and/or maximizing the number of successful bounces, may result in scoring points, etc.

This ‘bounding box’ game may be implemented on top of other windows (i.e., overlaid on these other windows) using the user-interface or activation techniques described previously, so it may occur within the bounding box or rectangle created by the user-interface operation (which was used to activate the mini-app) and the current mouse position. Therefore, the bounding box game may or may not be tied to a selection window on the computer desktop or within a window associated with another software program.

In some embodiments, when selected, a mini-app plays music or sound effects during the click-drag operation or another user-interface operation that is used to activate or select the mini-app.

In some embodiments, when selected, a mini-app checks for new content or data on remote servers or websites on a network (such as the Internet), and alerts the user by displaying a number, a message or other information in close proximity to the mouse cursor (such as within 1 in.). For example, this mini-app may check the user's account on Facebook.com (which is operated by Facebook, Inc. of Palo Alto, Calif.) to see if any of the user's friends have uploaded new photographs. If new photos are available, the mini-app may add a visual display near the cursor (or may change the display of the cursor itself) to indicate that new content is available. This change may also indicate the amount of new content, e.g., ‘12’ or ‘12 new photos.’ Moreover, the mini-app may optionally download some or all of the new content to the user's local computer. Additionally, using the mini-app, the user can access the new content either locally or remotely by, for example, clicking the mouse or using any of the other previously described user-interface operations or activation techniques.

In some embodiments, one or more of the mini-apps post content, data and/or achievements to social networks or other websites, either automatically or after receiving explicit consent from the user.

Note that the mini-apps may be designed to close immediately or to revert to a standby mode when the mouse or user-input device is released or placed into an un-clicked or un-touched state, or within a brief period of time after the release. Alternatively, the mini-apps may stay open on the computer screen until they are explicitly closed by the user. Furthermore, the function of a given mini-app may be temporarily paused, so the user's pointer, keyboard and/or operating-system behavior returns temporarily to the standard or default behavior prior to the user-interface operation (such as the click-drag operation).

The mini-app embodiments may include mini-apps that alter the display of: the computer desktop, icons or objects on the computer desktop, and/or other elements of the operating system. For example, mini-apps may alter the appearance of the Microsoft Windows Start box or some or all of the windows in Microsoft Windows™ Explorer (from the Microsoft Corporation of Redmond, Wash.), and/or one or more application windows (e.g., change the color, the geometry, and/or add patterns or animations)

Moreover, some or all of the user's mouse or user-interface-device data may be stored, either locally and/or on a remote server. This data may be displayed to the user or may be provided to other mini-apps (with the user's discretion/approval) to enable additional functionality. For example, meta-data about the user's mouse or user-interface-device usage may be calculated and presented or transmitted, such as: the total distance the user's input device is moved per unit of time, the total number of clicks or gestures performed by the user, a distribution of distance or clicks as a function of time or as a function of the active software program, the maximum number of clicks per unit of time, etc.

As described below with reference to FIG. 4, in some embodiments, one or more of the mini-apps may be activated by other applications or websites, either locally on the user's computer (or electronic device) and/or from a remote electronic device or server. For example, activity on Facebook.com (or an application within or associated with Facebook.com) may trigger an alert and/or action within a mini-app on the user's computer. Alternatively, actions within a mini-app may trigger an alert or activity in other applications or websites, either locally and/or on a remote server.

Furthermore, different users of one or more computers may be networked together to enable one user's behavior and/or mini-app usage to be communicated to another user, either synchronously or asynchronously. For example, one user may ‘throw’ an object from their computer desktop. This object may subsequently appear (or be displayed) on another user's computer desktop (with or without the consent of the receiving user). Alternatively or additionally, a user may send a secret ‘surprise’ to another user so that, at some future time, when the second user clicks on an icon or an object on their computer desktop, the surprise is revealed or displayed. In another example, two or more users may share a desktop wallpaper image so that when one user alters the wallpaper, the other user(s) sees the new image and vice-versa, either synchronously or asynchronously.

The preceding interaction between users may occur directly from within the software program (such as a mini-app) and/or the hooking software program using: peer-to-peer communication, communication through a central server, by sharing links on websites, and/or using another communication technique (such as instant messaging, email, a short message service, etc.). However, as described below, in some embodiments it is facilitated using a remote-activation technique with or without using the hooking software program.

We now describe the remote-activation technique, which can be used to perform an operation, such as providing the sensory information. FIG. 4 presents a flow chart illustrating a method 400 for performing an operation, which may be performed by an electronic device, such as electronic device 700 (FIG. 7), which may be a computer or a computer system. Note that this electronic device may be the same as or different from the electronic device that performs method 100 (FIG. 1). During method 400, the electronic device receives a request from another electronic device via a network (operation 410). In response to the request, the electronic device activates an application on the electronic device (operation 412).

Note that the application may include a web server. Moreover, the request may include a Hypertext Transfer Protocol request and the other electronic device may function as a client in a client-server architecture. Furthermore, the application may be included in or separate from an operating system of the electronic device.

Then, the electronic device performs the operation based on the request using the application (operation 416), where the operation is other than operations performed by the electronic device when the request was received. Additionally, the operation may include: providing the sensory information; and/or displaying a window with the sensory information, where the window may be superimposed over one or more other windows that were displayed on the electronic device prior to receiving the request.

In some embodiments, performing the operation is gated by the optional occurrence of an event (operation 414) after the request is received. This event may include a user-interface operation on the electronic device, such as a mouse or keyboard input or operation. For example, the user-interface operation may involve: when a cursor stops moving, when the cursor starts moving, and/or activation of an icon or object in the user interface (such as activating a key or icon in a physical or virtual keyboard). Alternatively or additionally, the event may include: a time of day, an expired time (such as an elapsed time since a previous event), activation of another application, activation of a particular operating-system operation, and/or a state of the user's electronic device.

The remote-activation technique may facilitate content delivery on the electronic device without using a web browser. For example, as noted previously, a mini-app may be activated remotely, users may be networked together (such as ‘throwing a sheep’ to another user) and/or advertising or information sponsored by a third party may be provided to the user. Thus, the remote-activation technique may facilitate functionality that is not currently supported by web browsers, including performing the operation regardless of what the user's computer is currently doing (for example, a new window with an animated sheep may be activated and superimposed over other windows, including an active window). Furthermore, the remote-activation technique may or may not execute independently of the user-interface technique, i.e., with or without using the hooking software program.

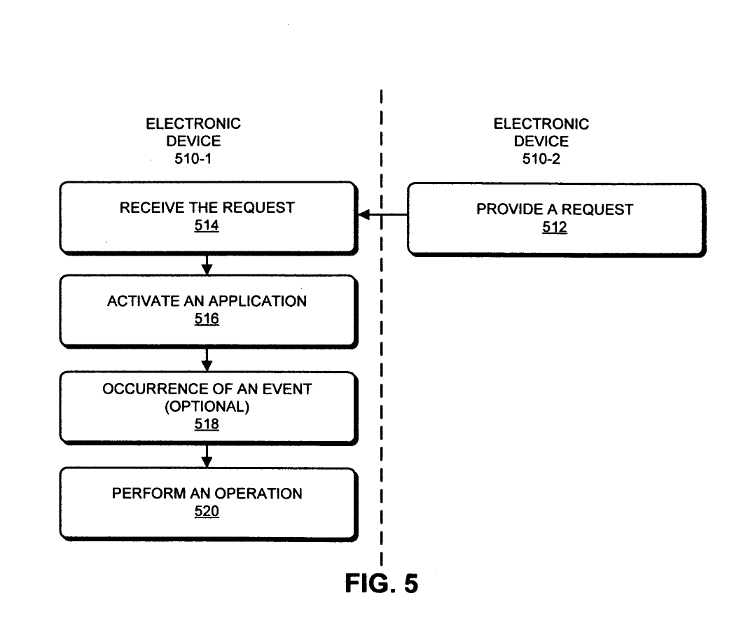

In an exemplary embodiment, the remote-activation technique is implemented using one or more computers, which communicate through a network, such as the Internet, i.e., using a client-server architecture. This is illustrated in FIG. 5, which presents a flow chart illustrating method 400. During this method, electronic device 510-2 provides a request (operation 512) that is received by electronic device 510-1 (operation 514). In response to the request, electronic device 510-1 activates an application (such as a mini-app) on electronic device 510-1 (operation 516). Then, electronic device 510-1 performs the operation based on the request using the application (operation 520). For example, the application may provide the sensory information. In some embodiments, performing the operation (operation 520) is gated by the optional occurrence of an event (operation 518). This event may include a user-interface operation on electronic device 510-1 (such as a mouse or keyboard input or operation), which may be detected by the hooking software program. Alternatively or additionally, the event may include state of electronic device 510-1, such as a time of day.

In some embodiments of methods 100 (FIG. 1) and/or 400 (FIGS. 4 and 5) there may be additional or fewer operations. Moreover, the order of the operations may be changed, and/or two or more operations may be combined into a single operation.

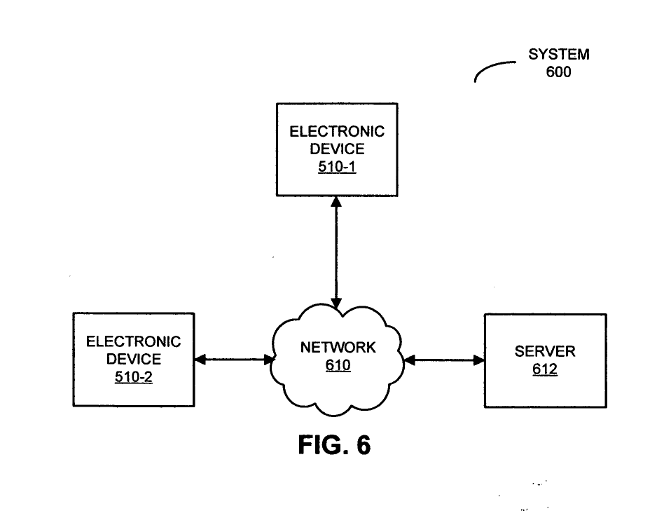

We now describe embodiments of a system. FIG. 6 presents a block diagram illustrating a system 600 that performs method 400 (FIGS. 4 and 5). In this system, a user of electronic device 510-1 may use one or more software programs or applications. The one or more software programs may be stand-alone applications that are resident on and which execute in an environment of electronic device 510-1 or portions of another application that is resident on and which executes on electronic device 510-1 (such as one or more software programs that are provided by server 612 or that are installed and which execute on electronic device 510-1). Alternatively, the user may interact with one or more web pages that are provided by server 612 via network 610, and which are rendered by a web browser on electronic device 510-1. In some embodiments, at least a portion of a given software program may be an application tool (such as a software application tool) that is embedded in a web page (and which executes in a virtual environment of the web browser). Thus, the software application tool may be provided to the user via a client-server architecture.

As discussed previously, an event may occur on electronic device 510-1, such as when the user performs a user-interface operation, e.g., a click-drag operation. This user-interface operation may be detected by a hooking software program, which is resident on and which executes in the environment of electronic device 510-1. Then, the hooking software program may provide information associated with the event to electronic device 510-1, for example, to another software program (such as a mini-app) that is resident on and which executes in the environment of electronic device 510-1. In response to the received information, electronic device 510-1 and/or the other software program provides the sensory information via the hooking software program, where the sensory information is other than sensory information associated with native operations executed in the environment during a user session prior to the event.

Alternatively or additionally, electronic device 510-1 may receive a request from electronic device 510-2 via network 610. In response to the request, electronic device 510-1 activates an application, such as the other software program, on electronic device 510-1. Then, electronic device 510-1 performs the operation (such as providing the sensory information) based on the request using the application, where the operation is other than operations performed by electronic device 510-1 when the request was received. In some embodiments, performing the operation is optionally gated by occurrence of the event. For example, the operation may be performed on electronic device 510-1 after the user performs the user-interface operation and/or based on a state of electronic device 510-1.

Note that information in system 600 may be stored at one or more locations in system 600 (i.e., locally or remotely). Moreover, because this data may be sensitive in nature, it may be encrypted. For example, stored data and/or data communicated via network 610 may be encrypted.

We now describe embodiments of an electronic device. FIG. 7 presents a block diagram illustrating an electronic device 700 (such as a computer or a computer system) that performs method 100 (FIG. 1) or 400 (FIG. 4 or 5). Electronic device 700 includes one or more processing units or processors 710, a communication interface 712, a user interface 714, and one or more signal lines 722 coupling these components together. Note that the one or more processors 710 may support parallel processing and/or multi-threaded operation, the communication interface 712 may have a persistent communication connection, and the one or more signal lines 722 may constitute a communication bus. Moreover, the user interface 714 may include: a display 716, a keyboard 718, and/or a pointer 720, such as a mouse.

Memory 724 in electronic device 700 may include volatile memory and/or non-volatile memory. More specifically, memory 724 may include: ROM, RAM, EPROM, EEPROM, flash memory, one or more smartcards, one or more magnetic disc storage devices, and/or one or more optical storage devices. Memory 724 may store an operating system 726 that includes procedures (or a set of instructions) for handling various basic system services for performing hardware-dependent tasks. Memory 724 may also store procedures (or a set of instructions) in a communication module 728. These communication procedures may be used for communicating with one or more electronic devices, computers and/or servers, including electronic devices, computers and/or servers that are remotely located with respect to electronic device 700.

Memory 724 may also include multiple program modules (or sets of instructions), including: hooking software program 730 (or a set of instructions), software program 732 (or a set of instructions), graphical module 734 (or a set of instructions), one or more software program(s) 736 (or a set of instructions) and/or encryption module 738 (or a set of instructions). Note that one or more of these program modules (or sets of instructions) may constitute a computer-program mechanism.

During method 100 (FIG. 1), hooking software program 730 may detect one or more event(s) 740, as well as associated information. For example, hooking software program 730 may detect one or more user-interface operations (such as a click-drag operation) performed by a user using user interface 714 when the information associated with one or more event(s) 740 is conveyed to an environment of electronic device 700, such as operating system 726. Then, the information associated with the one or more event(s) 740 is provided by hooking software program 730 to software program 732 (which may be a mini-app).

In response to the received information, software program 732 (and, more generally, electronic device 700) provides sensory information 742, which is other than native sensory information 744 that is associated with native operations 754 executed in the environment during a user session prior to the one or more event(s) 740. In particular, software program 732 may provide sensory information 742 via hooking software program 730. Note that native sensory information 744 may be associated with one or more software program(s) 736, such as one or more active software programs in electronic device 700.

In some embodiments, sensory information 742 includes graphical content (such as one or more images, an animation sequence and/or a game), and graphical module 734 is used to display this graphical content on a window in display 716. Moreover, sensory information 742 may be visually and contextually associated with at least a portion of native sensory information 744.

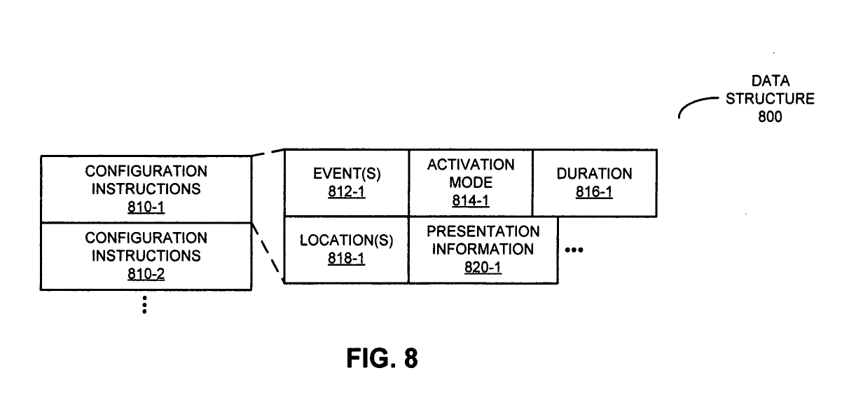

Note that sensory information 742 may be provided based on activation configuration instructions 746 and/or display configuration instructions 748, which may be provided by a user, and which may be stored in a data structure. This data structure is shown in FIG. 8, which presents a block diagram illustrating a data structure 800. In particular, data structure 800 may include configuration instructions 810. For example, configuration instructions 810-1 may include: one or more types of event(s) 812-1, an activation mode 814-1 (such as provide sensory information 742 in FIG. 7 ‘as soon as the one or more event(s) occur’ or ‘if the one or more event(s) have an optional duration 816-1’), one or more location(s) 818-1 (which specify positions of a pointer on display 716 in FIG. 7 that gate whether sensory information 742 in FIG. 7 is provided when the one or more event(s) 812-1 occur), presentation information 820-1 (such as display sensory information 742 in FIG. 7 ‘on top of all other information’ on display 716 in FIG. 7, ‘underneath all the other information’ on display 716 in FIG. 7 or ‘on top of all windows’ on display 716 in FIG. 7).

Referring back to FIG. 7, alternatively or additionally, during method 400 (FIGS. 4 and 5) one or more request(s) 750 are received from one or more other electronic devices using communication interface 712 and communication module 728. In response to the one or more request(s) 750, electronic device 700 activates software program 732 (for example, operating system 726 may activate software program 732). Then, electronic device 700 performs one or more operation(s) 752 based on the one or more requests 750 using software program 732. For example, the one or more operation(s) 752 may include providing sensory information 742. Note that the one or more operation(s) 752 are other than native operations 754, at least some of which may have been performed by electronic device 700 when the one or more request(s) 750 were received.

In some embodiments, performing the one or more operation(s) 752 is gated by occurrence of the one or more event(s) 740. In these embodiments, the one or more event(s) may include one or more user-interface operations and/or state information 756 (such as a time of day).

Because information in memory 724 may be sensitive in nature, in some embodiments at least some of the data stored in memory 724 and/or at least some of the data communicated using communication module 728 is encrypted using encryption module 738.

Instructions in the various modules in memory 724 may be implemented in: a high-level procedural language, an object-oriented programming language, and/or an assembly or machine language. Note that the programming language may be compiled or interpreted, e.g., configurable or configured, to be executed by the one or more processors 710.

Although electronic device 700 is illustrated as having a number of discrete items, FIG. 7 is intended to be a functional description of the various features that may be present in electronic device 700 rather than a structural schematic of the embodiments described herein. In practice, and as recognized by those of ordinary skill in the art, the functions of electronic device 700 may be distributed over a large number of electronic devices, computers or servers, with various groups of the electronic devices, computers or servers performing particular subsets of the functions. In some embodiments, some or all of the functionality of electronic device 700 may be implemented in one or more application-specific integrated circuits (ASICs) and/or one or more digital signal processors (DSPs).

Electronic devices and servers in system 600 (FIG. 6) and/or electronic device 700 may include one of a variety of devices capable of manipulating computer-readable data or communicating such data between two or more computing systems over a network, including: a personal computer, a laptop computer, a tablet computer, a mainframe computer, a portable electronic device (such as a cellular phone or PDA), a server and/or a client computer (in a client-server architecture). Moreover, network 610 (FIG. 6) may include: the Internet, World Wide Web (WWW), an intranet, LAN, WAN, MAN, or a combination of networks, or other technology enabling communication between computing systems.

User interface 200 (FIG. 2), user interface 300 (FIG. 3), system 600 (FIG. 6), electronic device 700 (FIG. 7) and/or data structure 800 may include fewer components or additional components. Moreover, two or more components may be combined into a single component, and/or a position of one or more components may be changed. In some embodiments, the functionality of system 600 (FIG. 6) and/or electronic device 700 may be implemented more in hardware and less in software, or less in hardware and more in software, as is known in the art.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

Note that only those claims specifically reciting “means for” or “step for” should be construed in the manner required under the sixth paragraph of 35 U.S.C. §112.

What is claimed is:

1. An electronic-device-implemented method for providing sensory information, comprising:
receiving information associated with an event from a hooking software program, wherein the information was detected by the hooking software program while the information was conveyed to an environment of the electronic device, and wherein the hooking software program executes in the environment; and
in response to the received information, providing sensory information via the hooking software program, wherein the sensory information is other than sensory information associated with native operations executed in the environment during a user session prior to the event.

2. The method of claim 1, wherein the environment includes an operating system of the electronic device.

3. The method of claim 1, wherein the sensory information is to be displayed in a window in a user interface of the electronic device; and
wherein the window is superimposed over a background that is associated with an operating system of the electronic device.

4. The method of claim 1, wherein the sensory information is associated with a software program that executes in the environment.

5. The method of claim 4, wherein the environment includes an operating system; and
wherein the software program is included in the operating system.

6. The method of claim 1, wherein the event includes a user-interface operation.

7. The method of claim 6, wherein the user-interface operation includes a click-drag operation; and
wherein the click-drag operation includes at least one of: a first drag-select operation that selects an object displayed in the user interface, a second drag-select operation that selects a region in the user interface that does not include the object, a first drag-drop operation that moves the object displayed in the user interface, a second drag-drop operation that creates a new object that is displayed in the user interface, and a click-hold operation in which a user-interface device is activated without moving the user-interface device.

8. The method of claim 1, wherein the hooking software program includes a hooking callback operation and a signal/slots notification operation which provide an intercepted-event notification-broadcast operation; and
wherein the intercepted-event notification-broadcast operation can notify multiple recipients in the environment based on the detected event.

9. The method of claim 1, wherein the sensory information is to be displayed in a window in a user interface of the electronic device; and
wherein the sensory information is associated with additional sensory information that is displayed in a second window in the user interface.

10. The method of claim 9, wherein the sensory information is visually and contextually associated with the additional sensory information.

11. The method of claim 1, wherein the sensory information is to be displayed in a window in a user interface of the electronic device; and
wherein the sensory information includes at least one of: one or more images, an animation sequence, and a game.

12. The method of claim 1, wherein the sensory information is to be displayed in a window in a user interface of the electronic device; and
wherein the window is semi-transparent, thereby allowing at least a portion of a second window to be observed through the window.

13. The method of claim 1, wherein the sensory information is to be displayed in a window in a user interface of the electronic device;
wherein the sensory information is provided based on display configuration instructions; and
wherein the display configuration instructions include at least one of:
positioning the window on top of a background that is associated with the environment;
positioning the window underneath other windows in the user interface; and
positioning the window on top of the other windows in the user interface.

14. The method of claim 1, wherein the event includes a user-interface operation;
wherein the sensory information is provided based on activation configuration instructions; and
wherein the activation configuration instructions include at least one of:
instructions to provide the sensory information if the user-interface operation has at least a minimum duration; instructions to provide the sensory information if the user-interface operation has a duration exceeding a pre-defined value; instructions to provide the sensory information if the user-interface operation occurs at an arbitrary location in the user interface; instructions to provide the sensory information if the user-interface operation occurs a location in the user interface that satisfies a predefined graphical characteristic; and instructions to provide the sensory information if the user-interface operation occurs in a predefined subset of the user interface.

15. A computer-program product for use in conjunction with an electronic device, the computer-program product comprising a computer-readable storage medium and a computer-program mechanism embedded therein for displaying additional sensory information associated with a software program, the computer-program mechanism including:
instructions for receiving information associated with an event from a hooking software program, wherein the information was detected by the hooking software program while the information was conveyed to an environment of the electronic device, and wherein the hooking software program executes in the environment; and
instructions for providing, in response to the received information, the sensory information via the hooking software program, wherein the sensory information is other than sensory information associated with native operations executed in the environment during a user session prior to the event.

16. The computer-program product of claim 15, wherein the sensory information is associated with a software program that executes in the environment.

17. The computer-program product of claim 15, wherein the event includes a user-interface operation.

18. The computer-program product of claim 15, wherein the sensory information is to be displayed in a window in a user interface of the electronic device; and
wherein the sensory information is associated with additional sensory information that is displayed in a second window in the user interface.

19. The computer-program product of claim 15, wherein the hooking software program includes a hooking callback operation and a signal/slots notification operation which provide an intercepted-event notification-broadcast operation; and
wherein the intercepted-event notification-broadcast operation can notify multiple recipients in the environment based on the detected event.

20. An electronic device, comprising:
one or more processors;
memory; and
a program module, wherein the program module is stored in the memory and configured to be executed by the processor, wherein the program module is to provide sensory information, the program module including:
instructions for receiving information associated with an event from a hooking software program, wherein the information was detected by the hooking software program while the information was conveyed to an environment of the electronic device, and wherein the hooking software program executes in the environment; and
instructions for providing, in response to the received information, the sensory information via the hooking software program, wherein the sensory information is other than sensory information associated with native operations executed in the environment during a user session prior to the event.
